(19) United States
(12) Patent Application Publication
(10) Pub. No.: US 2023/0076673 A1
(43) Pub. Date: Mar. 9, 2023

(54) ALL SOLID STATE BATTERY

(71) Applicant: TOYOTA JIDOSHA KABUSHIKI KAISHA, Toyota-shi (JP)

(72) Inventor: Ippei GOTO, Okazaki-shi (JP)

(73) Assignee: TOYOTA JIDOSHA KABUSHIKI KAISHA, Toyota-shi (JP)

(21) Appl. No.: 17/892,515

(22) Filed: Aug. 22, 2022

(30) Foreign Application Priority Data
Sep. 2, 2021 (JP) 2021-143027

(51) Int. Cl. H01M 10/0562; H01M 4/38

(52) U.S. Cl. CPC H01M 10/0562; H01M 4/386; H01M 2300/0068; H01M 2004/027

(57) ABSTRACT

A main object of the present disclosure is to provide an all solid state battery with low battery resistance even when the confining pressure applied to an electrode stacked body is low. The present disclosure achieves the object by providing an all solid state battery comprising an electrode stacked body including a cathode layer, an anode layer, and a solid electrolyte layer placed between the cathode layer and the anode layer; and the electrode stacked body is confined under confining pressure of 0 MPa or more and 2 MPa or less in a thickness direction; the anode layer includes an anode active material with a volume expansion rate due to charge of 105% or more; the solid electrolyte layer includes a solid electrolyte and a binder; and a ratio of the binder in the solid electrolyte layer is 4 volume % or more and 20 volume % or less.

### TECHNICAL FIELD

The present disclosure relates to an all solid state battery.

### BACKGROUND ART

An all solid state battery is a battery including a solid electrolyte layer between a cathode layer and an anode layer, and has advantages in that it is easy to simplify a safety device as compared with a liquid battery including a liquid electrolyte containing flammable organic solvents. Patent Literature 1 discloses a lithium all solid state battery comprising a battery element including an anode layer including an anode active material which is a Si simple substance or a Si alloy; a cathode layer; and a solid electrolyte layer formed between the anode layer and the cathode layer. Patent Literature 1 also discloses to confine the battery element under a confining pressure of 3 MPa or more and 20 MPa or less.

Patent Literature 2 discloses a separator for an all solid state battery, the separator comprising a solid electrolyte layer including a solid electrolyte and a hydrogenated rubber based resin. Patent Literature 3 discloses an all solid state battery comprising a stacked battery unit of two or more monopolar structure, wherein the battery is confined in the stacked direction of the stacked battery unit under confining pressure of 1.0 MPa or less.

### CITATION LIST

### Patent Literatures

Patent Literature 1: Japanese Patent Application Laid-Open (JP-A) No. 2020-092100
Patent Literature 2: JP-A No. 2020-102310
Patent Literature 3: JP-A No. 2020-140932

### SUMMARY OF DISCLOSURE

### Technical Problem

In an all solid state battery, ions and electrons are conducted via a solid/solid interface. From the viewpoint of ensuring the ion conductivity and the electron conductivity, a confining member configured to confine an electrode stacked body including a cathode layer, a solid electrolyte layer, and an anode layer along the thickness direction (stacked direction) is used in a common all solid state battery. For example, in an all solid state battery wherein the confining pressure applied to an electrode stacked body is designed to be low, there is an advantage that the size reduction of the confining member may be easily carried out. Meanwhile, when the confining pressure applied to the electrode stacked body is reduced, the battery resistance is likely to be increased.

The present disclosure has been made in view of the above circumstances, and a main object of the present disclosure is to provide an all solid state battery with low battery resistance even when the confining pressure applied to an electrode stacked body is low.

### Solution to Problem

The present disclosure provides an all solid state battery comprising an electrode stacked body including a cathode layer, an anode layer, and a solid electrolyte layer placed between the cathode layer and the anode layer; and the electrode stacked body is confined under confining pressure of 0 MPa or more and 2 MPa or less in a thickness direction; the anode layer includes an anode active material with a volume expansion rate due to charge of 105% or more; the solid electrolyte layer includes a solid electrolyte and a binder; and a ratio of the binder in the solid electrolyte layer is 4 volume % or more and 20 volume % or less.

According to the present disclosure, since the ratio of the binder in the solid electrolyte layer is in a predetermined range, the all solid state battery has low battery resistance even when the confining pressure applied to an electrode stacked body is low.

In the disclosure, a peeling strength between the solid electrolyte layer and the anode layer may be 0.20 N/cm or more.

The present disclosure also provides an all solid state battery comprising an electrode stacked body including a cathode layer, an anode layer, and a solid electrolyte layer placed between the cathode layer and the anode layer; and the electrode stacked body is confined under confining pressure of 0 MPa or more and 2 MPa or less in a thickness direction; the anode layer includes an anode active material with a volume expansion rate due to charge of 105% or more; the solid electrolyte layer includes a solid electrolyte and a binder; and a peeling strength between the solid electrolyte layer and the anode layer is 0.20 N/cm or more and 1.04 N/cm or less.

According to the present disclosure, since the peeling strength between the solid electrolyte layer and the anode layer is in a predetermined range, the all solid state battery has low battery resistance even when the confining pressure applied to an electrode stacked body is low.

In the disclosure, the anode active material may be a Si based active material.

In the disclosure, the solid electrolyte may be a sulfide solid electrolyte.

In the disclosure, the electrode stacked body may include an anode current collector at a location on opposite side to the solid electrolyte layer, with respect to the anode layer, and a rough surface may be formed on an anode layer side surface of the anode current collector.

### Advantageous Effects of Disclosure

The present disclosure exhibits effects that an all solid state battery with low battery resistance even when the confining pressure applied to an electrode stacked body is low, may be provided.

### BRIEF DESCRIPTION OF DRAWINGS

FIG. 1 is a schematic cross-sectional view illustrating an example of an all solid state battery in the present disclosure.

FIG. 2 is a schematic cross-sectional view illustrating an example of an all solid state battery in the present disclosure.

FIG. 3 is a graph showing the results of Examples 1 to 9 and Comparative Examples 1 to 11.

### DESCRIPTION OF EMBODIMENTS

Hereinafter, the all solid state battery in the present disclosure is described in detail.

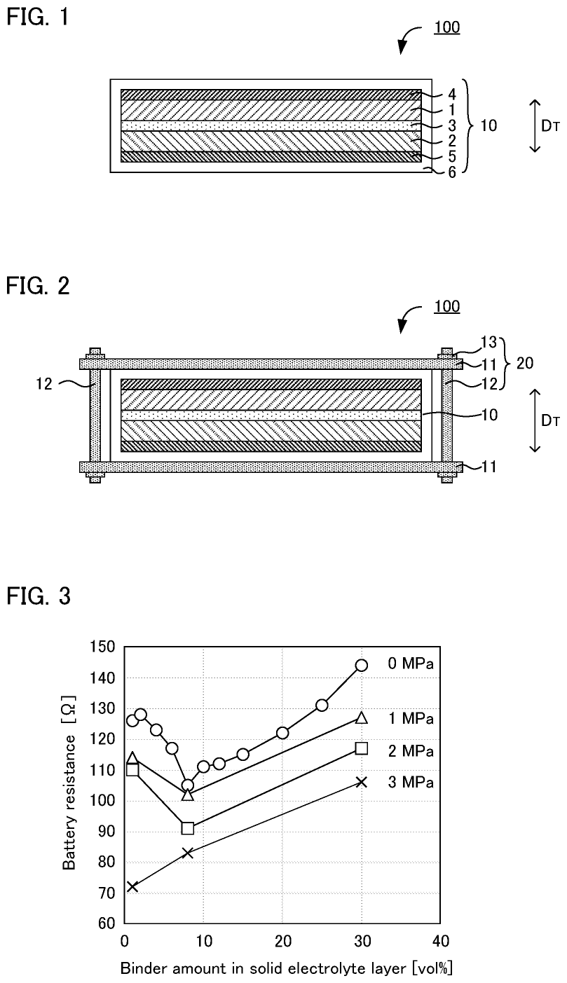

FIG. 1 is a schematic cross-sectional view illustrating an example of an all solid state battery in the present disclosure. All solid state battery 100 illustrated in FIG. 1 comprises electrode stacked body 10. The electrode stacked body 10 includes cathode layer 1, anode layer 2, and solid electrolyte layer 3 placed between the cathode layer 1 and the anode layer 2. Further, the electrode stacked body 10 includes cathode current collector 4 on the surface of the cathode layer 1 which is opposite to the solid electrolyte layer 3, and includes anode current collector 5 on the surface of the anode layer 2 which is opposite to the solid electrolyte layer 3. That is, the electrode stacked body 10 includes the cathode current collector 4, the cathode layer 1, the solid electrolyte layer 3, the anode layer 2, and the anode current collector 5 in this order along the thickness direction DT. The electrode stacked body 10 further includes exterior body 6 which houses the cathode current collector 4, the cathode layer 1, the solid electrolyte layer 3, the anode layer 2, and anode current collector 5.

The electrode stacked body 10 is confined under confining pressure of 0 MPa or more and 2 MPa or less in the thickness direction DT. In FIG. 1, electrode stacked body 10 is confined under confining pressure of 0 MPa. That is, the confining pressure by a confining jig is not applied to the electrode stacked body 10 in FIG. 1. Meanwhile, as illustrated in FIG. 2, in addition to the electrode stacked body 10, the all solid state battery 100 may be provided with confining member 20 configured to apply a confining pressure to the electrode stacked body 10, in the thickness direction DT. Also, the anode layer 2 in FIG. 1 includes an anode active material whose volume expands due to charge, and the volume contracts due to discharge. Meanwhile, the solid electrolyte layer 3 in FIG. 1 includes a solid electrolyte and a binder. Further, in FIG. 1, the anode layer 2 and the solid electrolyte layer 3 are adhered tightly to each other.

According to the present disclosure, since the adherence between the anode layer and the solid electrolyte layer is high, the all solid state battery has low battery resistance even when the confining pressure applied to an electrode stacked body is low. As described above, ions and electrons are conducted via a solid/solid interface in an all solid state battery. From the viewpoint of ensuring the ion conductivity and the electron conductivity, a confining member configured to confine an electrode stacked body including a cathode layer, a solid electrolyte layer, and an anode layer along the thickness direction (stacked direction) is used in a common all solid state battery. For example, in an all solid state battery wherein the confining pressure applied to an electrode stacked body is designed to be low, there is an advantage that the size reduction of the confining member may be easily carried out. Meanwhile, when the confining pressure applied to the electrode stacked body is reduced, the battery resistance is likely to be increased.

In contrast to this, in the present disclosure, by making the adherence between the anode layer and the solid electrolyte layer high, the all solid state battery has low battery resistance even when the confining pressure applied to an electrode stacked body is low. When the confining pressure is low, the joining state between the anode layer and the solid electrolyte layer is deteriorated due to the expansion/contraction of the anode active material so that the contact resistance is increased. In contrast to this, by making the adherence between the anode layer and the solid electrolyte layer high, the joining state between the anode layer and the solid electrolyte layer is maintained so that the increase of the contact resistance is suppressed. Also, as described in Comparative Examples later, when the confining pressure is 3 MPa or more, good joining state is maintained, regardless of the adherence between the anode layer and the solid electrolyte layer. Therefore, the problem caused by the adherence between the anode layer and the solid electrolyte layer is a peculiar problem when the confining pressure applied to the electrode stacked body is low.

1. Electrode Stacked Body

The all solid state battery in the present disclosure comprises an electrode stacked body including a cathode layer, an anode layer, and a solid electrolyte layer placed between the cathode layer and the anode layer. The electrode stacked body may further include a cathode current collector, an anode current collector, and an exterior body.

The electrode stacked body is usually confined under confining pressure of 0 MPa or more and 2 MPa or less in a thickness direction. As described above, a state wherein the confining pressure is 0 MPa means a state wherein the confining pressure by a confining jig is not applied to the electrode stacked body 10. Also, the confining pressure applied to the electrode stacked body may be 0.05 MPa or more, and may be 0.1 MPa or more. Meanwhile, the confining pressure applied to the electrode stacked body may be 1.5 MPa or less, and may be 1.0 MPa or less. Also, the electrode stacked body is preferably confined under the confining pressure described above, in an uncharged state or in a completely discharged state.

(1) Solid Electrolyte Layer

The solid electrolyte layer is a layer placed between the cathode layer and the anode layer, and includes a solid electrolyte and a binder. The ratio of the binder in the solid electrolyte layer is, for example, 4 volume % or more, may be 6 volume % or more, and may be 8 volume % or more. When the ratio of the binder is too low, preferable joining state between the anode layer and the solid electrolyte layer may not be maintained. Meanwhile, the ratio of the binder in the solid electrolyte layer is, for example, 20 volume % or less. The ratio of the binder may be less than 20 volume %, and may be 19 volume % or less. When the ratio of the binder is too high, the ion conductivity in the solid electrolyte layer is lowered so that the battery resistance may be increased.

Also, the peeling strength between the solid electrolyte layer and the anode layer is regarded as Sₚ. Sₚ is, for example, 0.20 N/cm or more, may be 0.32 N/cm or more, and may be 0.41 N/cm or more. When Sₚ is too low, preferable joining state between the anode layer and the solid electrolyte layer may not be maintained. Meanwhile, Sₚ is, for example, 2.00 N/cm or less, 1.50 N/cm or less, may be 1.04 N/cm or less, and may be 1.00 N/cm or less. Details for the method for measuring peeling strength is described in Examples later.

(i) Solid Electrolyte

The solid electrolyte layer includes a solid electrolyte. Examples of the solid electrolyte may include an inorganic solid electrolyte such as a sulfide solid electrolyte, an oxide solid electrolyte, a nitride solid electrolyte, and a halide solid electrolyte. The sulfide solid electrolyte preferably includes sulfur (S) as a main component of an anion element, the oxide solid electrolyte preferably includes oxygen (O) as a main component of an anion element, the nitride solid electrolyte preferably includes nitrogen (N) as a main component of an anion element. The halide solid electrolyte preferably includes halogen (X) as a main component of an anion element.

The sulfide solid electrolyte preferably includes, for example, a Li element, an A element (A is at least one kind of P, As, Sb, Si, Ge, Sn, B, Al, Ga, and In), and a S element. Also, the sulfide solid electrolyte may further include at least one of an O element and a halogen element. Examples of the halogen element may include a F element, a Cl element, a Br element, and an I element.

It is preferable that the sulfide solid electrolyte includes an anion structure of an ortho composition (such as PS₄³⁻structure, SiS₄⁴⁻structure, GeS₄⁴⁻structure, AlS₃³⁻structure, and BS₃³⁻structure) as the main component of the anion structure. The reason therefor is to allow a high chemical stability. The ratio of the anion structure of an ortho composition to all the anion structures in the sulfide solid electrolyte is, for example, 70 mol % or more, and may be 90 mol % or more.

The sulfide solid electrolyte may be an amorphous, and may be a crystalline. In the latter case, the sulfide solid electrolyte includes a crystal phase. Examples of the crystal phase may include a Thio-LISICON type crystal phase, a LGPS type crystal phase, and an argyrodite type crystal phase.

The composition of the sulfide solid electrolyte is not particularly limited, and examples thereof may include xLi₂S·(100−x)P₂S₅ (70≤x≤80), yLiI·zLiBr·(100−y−z) (xLi₂S·(1−x)P₂S₅ (0.7≤x≤0.8), 0≤y≤30, 0≤z≤30).

The sulfide solid electrolyte may have the composition represented by the general formula (1): Li₄−ₓGe₁−ₓPₓS₄ (0<x<1). In the general formula (1), at least a part of Ge may be substituted with at least one of Sb, Si, Sn, B, Al, Ga, In, Ti, Zr, V, and Nb. Also, in the general formula (1), at least a part of P may be substituted with at least one of Sb, Si, Sn, B, Al, Ga, In, Ti, Zr, V, and Nb. In the general formula (1), a part of Li may be substituted with at least one of Na, K, Mg, Ca, and Zn. In the general formula (1), a part of S may be substituted with a halogen (at least one of F, Cl, Br, and

Examples of other composition of the sulfide solid electrolyte may include Li_{7-x-2y}PS_{6-x-y}X_{y}, Li_{8-x-2y}SiS_{6-x-y}X_{y}, and Li_{8-x-2y}GeS_{6-x-y}X_{y}. In these compositions, X is at least one kind of F, Cl, Br, and I, and x and y satisfy 0≤x, 0≤y.

Also, examples of the oxide solid electrolyte may include a solid electrolyte including a Li element, a Y element (Y is at least one kind of Nb, B, Al, Si, P, Ti, Zr, Mo, W and S), and an O element. Specific examples of the oxide solid electrolyte may include garnet type solid electrolytes such as Li₇La₃Zr₂O₁₂, Li₇₋ₓLa₃(Zr₂₋ₓNbₓ)O₁₂, (0≤x≤2), Li₅La₃Nb₂O₁₂; perovskite type solid electrolyte such as (Li, La)TiO₃, (Li, La)NbO₃, (Li, Sr) (Ta, Zr)O₃; nasicon type solid electrolytes such as Li(Al, Ti) (PO₄)₃, and Li(Al, Ga) (PO₄)₃; Li—P—O type solid electrolytes such as Li₃PO₄, LIPON (a compound obtained by substituting a part of O of Li₃PO₄ with N); Li—B—O type solid electrolytes such as Li₃BO₃, and a compound obtained by substituting a part of O of Li₃BO₃ with C.

(ii) Binder

The solid electrolyte layer includes a binder. Examples of the binder may include rubber based binders such as butadiene rubber, butadiene hydrorubber, styrene butadiene rubber (SBR), styrene butadiene hydrorubber, nitrile-butadiene rubber, nitrile-butadiene hydrorubber, and ethylene-propylene rubber; and fluorine based binders such as polyvinylidene fluoride (PVDF), polyvinylidene fluoride-polyhexafluoropropylene copolymer (PVDF-HFP), polytetrafluoroethylene, and fluororubber.

Also, other examples of the binder may include polyolefin based thermoplastic resins such as polyethylene, polypropylene, and polystyrene; imide based resins such as polyimide and polyamide-imide; amide based resins such as polyamide; acrylate resins such as polymethyl acrylate, polyethyl acrylate, polypropyl acrylate, polybutyl acrylate, polyhexyl acrylate, poly2-ethylhexyl acrylate, polydecyl acrylate, and polyacrylic acid; methacrylate resins such as polymethyl methacrylate, polyethyl methacrylate, polybutyl methacrylate, poly2-ethylhexyl methacrylate, and polymethacrylic acid; polycarboxylic acid such as polyitaconic acid, polycrotonic acid, polyfumaric acid, polyangelic acid, and carboxymethyl cellulose.

Also, other examples of the binder may include polyethylene oxide, polypropylene oxide, polyacrylonitrile, polyethylene glycol dimethacrylate, polyethylene glycol acrylate, polyethylene vinyl acetate, polyglycidol, polysiloxane, polydimethylsiloxane, polyvinyl acetate, polyvinyl alcohol, polycarbonate, polyamine, polyalkyl carbonate, polynitrile, polydiene, polyphosphazene, unsaturated polyesters obtained by copolymerizing maleic anhydride and glycols, and polyethylene oxide derivatives including a substituent group. Also, a copolymer obtained by copolymerizing two kinds or more monomers constituting the polymers specifically described above may be selected as the binder. Also, polysaccharides such as glycogen, cellulose, chitin, agarose, carrageenan, heparin, hyaluronan, pectin, amylopectin, xyloglucan, and amylose may be used as the binder. Also, these binders may also be used as a dispersion fluid such as an emulsion.

(iii) Solid Electrolyte Layer

The solid electrolyte layer in the present disclosure includes a solid electrolyte and a binder. The solid electrolyte layer may be constituted with a single layer, and may be constituted with a plurality of layers. The thickness of the solid electrolyte layer is, for example, 0.1 μm or more and 1000 μm or less. The method for forming a solid electrolyte layer is not particularly limited, and examples thereof may include a method wherein a substrate (such as a release sheet, a cathode layer, or an anode layer) is coated with a slurry including a solid electrolyte, a binder, and a dispersing medium, and then, dried.

(2) Anode Layer

The anode layer is a layer including at least an anode active material, and may include at least one of a solid electrolyte, a conductive material, and a binder as necessary.

The volume of the anode active material expands due to charge, and the volume contracts due to discharge. In the anode active material, the volume expansion rate due to charge is, for example, 105% or more, may be 110% or more, may be 150% or more, and may be 200% or more. The volume expansion rate due to charge means a ratio(V₂/V₁) of the volume V₂ of an anode active material charged to a theoretical capacity, with respect to the volume V₁ of an uncharged anode active material. The volume expansion ratio due to charge may be determined from, for example, the variation of a XRD lattice constant of before and after a charge. It may also be determined from a cross-sectional SEM image of an anode active material before and after a charge.

Examples of the anode active material may include a Si based active material, a Sn based active material, and a carbon active material. The Si based active material is an active material including a Si element. Examples of the Si based active material may include a Si simple substance, a Si alloy, and a Si oxide. The Si alloy preferably includes a Si element as a main component. The ratio of the Si element in the Si alloy may be, for example, 50 mol % or more, may be 70 mol % or more, and may be 90 mol % or more. Examples of the Si alloy may include a Si—Al based alloy, a Si—Sn based alloy, a Si—In based alloy, a Si—Ag based alloy, a Si—Pb based alloy, a Si—Sb based alloy, a Si—Bi based alloy, a Si—Mg based alloy, a Si—Ca based alloy, a Si—Ge based alloy, and a Si—Pb based alloy. The Si alloy may be a two-component based alloy, and may be a multi-component based alloy of three or more components based. Examples of the Si oxide may include SiO.

The Sn based active material is an active material including a Sn element. Examples of the Sn based active material may include a Sn simple substance, and a Sn alloy. The Sn alloy preferably includes a Sn element as a main component. The ratio of the Sn element in the Sn alloy may be, for example, 50 mol % or more, may be 70 mol % or more, and may be 90 mol % or more. Also, examples of the carbon active material may include mesocarbon microbead (MCMB), highly oriented pyrolytic graphite (HOPG), hard carbon, and soft carbon.

Examples of the shape of the anode active material may include a granular shape. The average particle size (D₅₀) of the anode active material is, for example, 10 nm or more, and may be 100 nm or more. Meanwhile, the average particle size (D₅₀) of the anode active material is, for example, 50 μm or less, and may be 20 μm or less. The average particle size (D₅₀) may be calculated from the measurement by, for example, a laser diffraction type particle size distribution meter, and a scanning electron microscope (SEM).

The anode layer may include a conductive material. Examples of the conductive material may include a carbon material, a metal particle, and a conductive polymer. Examples of the carbon material may include particulate carbon materials such as acetylene black (AB) and Ketjen black (KB); and fibrous carbon materials such as carbon fiber, carbon nanotube (CNT), and carbon nanofiber (CNF).

The solid electrolyte and the binder used for the anode layer may be in the same contents as those described in “(1) Solid electrolyte layer” above; thus, the description herein is omitted. The thickness of the anode layer is, for example, 0.1 μm or more and 1000 μm or less. The method for forming an anode layer is not particularly limited, and examples thereof may include a method wherein a substrate (such as an anode current collector) is coated with an anode slurry including an anode active material, and a dispersing medium, and then, dried. The anode slurry may include at least one of the conductive material, the solid electrolyte, and the binder described above.

(3) Cathode Layer

The cathode layer is a layer including at least a cathode active material, and may include at least one of a solid electrolyte, a conductive material, and a binder, as necessary. Examples of the cathode active material may include an oxide active material. Examples of the oxide active material may include rock salt bed type active materials such as LiCoO₂, LiMnO₂, LiNiO₂, LiVO₂, and LiNi_{1/3}Co_{1/3}Mn_{1/3}O₂; spinel type active materials such as LiMn₂O₄, Li₄Ti₅O₁₂, and Li(Ni_{0.5}Mn_{1.5})O₄; and olivine type active materials such as LiFePO₄, LiMnPO₄, LiNiPO₄, and LiCoPO₄.

A protective layer including a Li ion conductive oxide may be formed on the surface of the oxide active material. The reason therefor is to suppress the reaction of the oxide active material with the solid electrolyte. Examples of the Li ion conductive oxide may include LiNbO₃. The thickness of the protective layer is, for example, 1 nm or more and 30 nm or less. Further, as the cathode active material, for example, Li₂S may also be used.

Examples of the shape of the cathode active material may include a granular shape. The average particle size (D₅₀) of the cathode active material is not particularly limited, and is, for example, 10 nm or more, and may be 100 nm or more. Meanwhile, the average particle size (D₅₀) of the cathode active material is, for example, 50 μm or less, and may be 20 μm or less.

The conductive material, the solid electrolyte, and the binder used for the cathode layer may be in the same contents as those described in “(1) Solid electrolyte layer” and “(2) Anode layer” above; thus, the description herein is omitted. The thickness of the cathode layer is, for example, 0.1 μm or more and 1000 μm or less. The method for forming a cathode layer is not particularly limited, and examples thereof may include a method wherein a substrate (such as a cathode current collector) is coated with a cathode slurry including a cathode active material, and a dispersing medium, and then, dried. The cathode slurry may include at least one of the conductive material, the solid electrolyte, and the binder described above.

(4) Electrode Stacked Body

The electrode stacked body in the present disclosure includes a cathode layer, an anode layer, and a solid electrolyte layer placed between the cathode layer and the anode layer. Here, when a set of a cathode layer, a solid electrolyte layer, and an anode layer is regarded as a power generation unit, the electrode stacked body may include only one power generation unit, and may include two or more of these. When the electrode stacked body includes two or more power generation units, these power generation units may be connected in series, and may be connected in parallel.

The electrode stacked body may include a cathode current collector configured to collect currents of the cathode layer. The cathode current collector is typically placed on a position opposite to the solid electrolyte layer, with respect to the cathode layer. Examples of the materials for the cathode current collector may include stainless steel, aluminum, nickel, iron, titanium, and carbon. Examples of the shape of the cathode current collector may include a foil shape, and a mesh shape.

The electrode stacked body may include an anode current collector configured to collect currents of the anode layer. The anode current collector is typically placed on a position opposite to the solid electrolyte layer, with respect to the anode layer. Examples of the materials for the anode current collector may include stainless steel, copper, nickel, and carbon. Examples of the shape of the anode current collector may include a foil shape, and a mesh shape. A rough surface may be formed on an anode layer side surface of the anode current collector. The adhesion of the anode current collector and the anode layer is improved by the rough surface, and as the result, the battery resistance is reduced. The rough surface is referred to as a surface with a surface roughness Rz (ten-point average roughness) of 0.6 μm or more. The surface roughness Rz of the rough surface may be 1.0 μm or more, may be 1.5 μm or more, and may be 2.0 μm or more.

The electrode stacked body may include an exterior body which houses at least the power generation unit described above. Examples of the exterior body may include a laminate type exterior body, and a case type exterior body. The laminate type exterior body includes at least a structure wherein a heat sealing layer and a metal layer are laminated. The laminate type exterior body may include a heat sealing layer, a metal layer, and a resin layer, along the thickness direction, in this order. Examples of the material of the heat sealing layer may include olefin based resins such as polypropylene (PP), and polyethylene (PE). Examples of the material of the metal layer may include aluminum, aluminum alloy, and stainless steel. Examples of the material of the resin layer may include polyethylene terephthalate (PET), and nylon.

2. Confining Member

The all solid state battery in the present disclosure may or may not be provided with a confining member. The confining member is a member which applies a confining pressure to the electrode stacked body in the thickness direction. The structure of the confining member is not particularly limited, a known structure may be employed. Incidentally, the confining member is usually a member different from the exterior body described above. For example, confining member 20 illustrated in FIG. 2 includes two plate shaped sections 11 placed on both sides of the electrode stacked body 10, one or two or more rod shaped section 12 which connects the two plate shaped sections 11, and adjusting section 13 connected to the rod shaped section 12 configured to adjust the confining pressure.

3. All Solid State Battery

The all solid state battery in the present disclosure is typically an all solid state lithium ion secondary battery. The use of the all solid state battery is not particularly limited, and examples thereof may include a power supply of a vehicle such as a hybrid electric vehicle (HEV), a plug-in hybrid electric vehicle (PHEV), a battery electric vehicle (BEV), a gasoline-powered vehicle, and a diesel-powered vehicle. In particular, it is preferably used in the driving power supply of a hybrid electric vehicle, a plug-in hybrid electric vehicle, or a battery electric vehicle. Also, the all solid state battery in the present disclosure may be used as a power source for moving objects other than vehicles (such as railroad vehicles, ships, and airplanes), and may be used as a power source for electric appliances such as information processing apparatuses.

Incidentally, the present disclosure is not limited to the embodiments. The embodiments are exemplification, and any other variations are intended to be included in the technical scope of the present disclosure if they have substantially the same constitution as the technical idea described in the claim of the present disclosure and offer similar operation and effect thereto.

### EXAMPLES

### Example 1

<Production of Cathode Structure>

As a cathode active material, LiNi_{1/3}Co₁Mn_{1/3}O₂ powder having average particle size (D₅₀) measured based on a laser diffraction/scattering method of 5 μm was used. Then, the surface of the cathode active material was coated with LiNbO₃ by a sol-gel method. Also, as a sulfide solid electrolyte, 15LiBr·10LiI·75(0.75Li₂S·0.25P₂S₅) glass ceramic having average particle size (D₅₀) measured based on a laser diffraction/scattering method of 2.5 μm was used.

Thereafter, the cathode active material and the sulfide solid electrolyte were weighed so as the weight ratio was cathode active material:sulfide solid electrolyte75:25, these were mixed, and a first mixture was obtained. Then, the materials were weighed so as a SBR (styrene butadiene rubber) based binder was 3 weight parts, and a conductive material (carbon nanofiber CNF) was 10 weight parts, with respect to 100 weight parts of the cathode active material, and these were added to the first mixture to obtain a second mixture. Then, a dispersing medium (butyl butyrate) was added to the second mixture, the solid content concentration was adjusted to 60 weight %, an ultrasonic dispersion treatment was carried out for 1 minute, and a cathode slurry was obtained.

A cathode current collector (an aluminum foil, thickness of 15 μm) was uniformly coated with the obtained cathode slurry by a blade coating, so as the coating weight was 15 mg/cm², and was dried at 100° C. for 60 minutes. Thereby, a cathode structure including a cathode current collector and a cathode layer was obtained.

<Production of Anode Structure>

As an anode active material, Si powder having average particle size (D₅₀) measured based on a laser diffraction/scattering method of 5 μm was used. Also, as a sulfide solid electrolyte, 15LiBr·10LiI·75(0.75Li₂S·0.25P₂S₅) glass ceramic having average particle size (D₅₀) measured based on a laser diffraction/scattering method of 2.5 μm was used.

Thereafter, the anode active material and the sulfide solid electrolyte were weighed so as the weight ratio was anode active material:sulfide solid electrolyte=50:50, these were mixed, and a third mixture was obtained. Then, the materials were weighed so as a SBR based binder was 3 weight parts, and a conductive material (CNF) was 10 weight parts, with respect to 100 weight parts of the anode active material, and these were added to the third mixture to obtain a fourth mixture. Then, a dispersing medium (butyl butyrate) was added to the fourth mixture, the solid content concentration was adjusted to 40 weight %, an ultrasonic dispersion treatment was carried out for 1 minute, and an anode slurry was obtained.

An anode current collector (a roughened copper foil, thickness of 25 μm, Rz5 μm) was uniformly coated with the obtained anode slurry by a blade coating, so as the coating weight was 3 mg/cm², and was dried at 100° C. for 60 minutes. Thereby, an anode structure including an anode current collector and an anode layer was obtained.

<Production of Solid Electrolyte Layer>

As a sulfide solid electrolyte, 15LiBr·10LiI·75(0.75Li₂S·0.25P₂S₅) glass ceramic having average particle size (D₅₀) measured based on a laser diffraction/scattering method of 2.5 μm was used. Also, as a binder, a SBR based binder was used.

Thereafter, the sulfide solid electrolyte and the binder were weighed so as the volume ratio was sulfide solid electrolyte:binder96:4, these were mixed, and a fifth mixture was obtained. Then, a dispersing medium (butyl butyrate) was added to the fifth mixture, the solid content concentration was adjusted to 50 weight %, an ultrasonic dispersion treatment was carried out for 1 minute, and a slurry for a solid electrolyte layer was obtained.

A release film (Cerapeel WZ, from Toray Industries, Inc., thickness of 25 μm) was uniformly coated with the obtained slurry by a blade coating, so as the coating weight was 6 mg/cm² (thickness of 30 μm), and was dried at 100° C. for 60 minutes. Thereby, a transfer member including a release film and a solid electrolyte layer was obtained.

<Production of all Solid State Battery>

The anode structure and the transfer member were respectively punched out to a square of 1.4 cm×1.4 cm. Also, the cathode structure was punched out to a square of 1 cm×1 cm. Then, the anode layer in the anode structure and the solid electrolyte layer in the transfer member were stacked, was pressed under pressing pressure of 1 ton/cm², and then, the release film was peeled off from the transfer member. Thereby, a first structure including the anode current collector, the anode layer, and the solid electrolyte layer was obtained. Then, the solid electrolyte layer in the first structure and the cathode layer in the cathode structure were stacked, and was pressed under pressing pressure of 3 ton/cm². Thereby, a second structure including the anode current collector, the anode layer, the solid electrolyte layer, the cathode layer, and the cathode current collector was obtained. Then, by sealing the second structure by an exterior body (aluminum laminate film) previously provided with a cathode terminal and an anode terminal, an electrode stacked body was obtained. A confining pressure (constant size confining) was not particularly applied to the obtained electrode stacked body, and was used as an all solid state battery (confining pressure0 MPa).

<Production of Sample for Peeling Strength Measurement>

A roughened copper foil (thickness of 25 μm) same as the anode current collector described above was uniformly coated with the slurry for a solid lelectrolyte layer described above by a blade coating, so as the coating weight was 6 mg/cm² (thickness of 30 μm) and was dried at 100° C. for 60 minutes. Thereby, a third structure including a roughened copper foil and a solid electrolyte layer was obtained. Then, the third structure and the anode structure were respectively cut out to a strip of 2.5 cm×10 cm.

Thereafter, the solid electrolyte layer in the third structure and the anode in the anode structure were stacked, and pressed under pressing pressure of 3 ton/cm². Thereby, a sample including anode current collector, anode layer, solid electrolyte layer, and the roughened copper foil was obtained.

### Examples 2 to 9, and Comparative Examples 1 to 11

An all solid state battery was produced in the same manner as in Example 1 except that the binder amount in the solid electrolyte layer and the confining pressure (constant size confining) were changed to the values described in Table 1. Also, a sample for peeling strength measurement was produced in the same manner as in Example 1 except that the binder amount in the solid electrolyte layer was changed to the values described in Table 1.

{Evaluation}

<Peeling Strength Measurement>

Using the samples produced in Examples 1 to 9, and Comparative Examples 1 to 11, the peeling strength between the anode layer and the solid electrolyte layer was measured. The measurement was carried out by the procedure described in JIS6854-3 (Adhesives-peeling adhesive strength test method-Part 3: T type peeling). The results are shown in Table 1.

<Resistance Measurement>

Using the all solid state batteries obtained in Examples 1 to 9, and Comparative Examples 1 to 11, a resistance measurement was carried out. The measurement was carried out by the following procedure. Firstly, the all solid state battery was CCCV charged at current rate of 1 mA until 4.5 V (current cut value: 0.01 mA). Then, the all solid state battery was CCCV discharged at current rate of 1 mA until 4.0 V at (current cut value: 0.01 mA). Then, the all solid state battery was stand still for an hour, CC discharged under the conditions of current rate of 10 mA for 10 seconds, and the battery resistance was determined according to law of Ohm. The results are shown in Table 1 and FIG. 3.

TABLE 1

| | Binder | Peeling | Confining | Battery |
|---|---|---|---|---|
| | amount | strength | pressure | resistance |
| | (vol %) | (N/cm) | (MPa) | (Ω) |
| Example 1 | 4 | 0.20 | 0 | 123 |
| Example 2 | 6 | 0.32 | | 117 |
| Example 3 | 8 | 0.41 | | 105 |
| Example 4 | 10 | 0.53 | | 111 |
| Example 5 | 12 | 0.62 | | 112 |
| Example 6 | 15 | 0.76 | | 115 |
| Example 7 | 20 | 1.04 | | 122 |
| Example 8 | 8 | 0.42 | 1 | 102 |
| Example 9 | 8 | 0.40 | 2 | 91 |
| Comp. Ex. 1 | 1 | 0.05 | 0 | 126 |
| Comp. Ex. 2 | 2 | 0.10 | | 128 |
| Comp. Ex. 3 | 25 | 1.34 | | 131 |
| Comp. Ex. 4 | 30 | 1.56 | | 144 |
| Comp. Ex. 5 | 1 | 0.05 | 1 | 114 |
| Comp. Ex. 6 | 30 | 1.54 | | 127 |
| Comp. Ex. 7 | 1 | 0.05 | 2 | 110 |
| Comp. Ex. 8 | 30 | 1.55 | | 117 |
| Comp. Ex. 9 | 1 | 0.05 | 3 | 72 |
| Comp. Ex. 10 | 8 | 0.40 | | 83 |
| Comp. Ex. 11 | 30 | 1.48 | | 106 |

As shown in Table 1 and FIG. 3, when the confining pressure was 3 MPa (Comparative Examples 9 to 11), the battery resistance increased as the binder amount in the solid electrolyte layer increased. In contrast to this, when the confining pressure was 0 MPa or more and 2 MPa or less (Examples 1 to 9 and Comparative Examples 1 to 8), it was confirmed that a valley portion wherein the battery resistance decreased, occurred as the binder amount in the solid electrolyte layer increased. Specifically, it was confirmed that, when the binder amount was 4 volume % or more and 20 volume % or less, as in Examples 1 to 9, a valley portion occurred and the battery resistance was low. Also, there was a correlation between the binder amount in the solid electrolyte layer and the peeling strength between the anode layer and the solid electrolyte layer. Specifically, it was confirmed that, when the peeling strength was 0.20 N/cm or more and 1.04 N/cm or less, as in Examples 1 to 9, a valley portion occurred and the battery resistance was low.

### REFERENCE SIGNS LIST

1 . . . cathode layer
2 . . . anode layer
3 . . . solid electrolyte layer
4 . . . cathode current collector
5 . . . anode current collector
6 . . . exterior body
10 . . . all solid state battery

What is claimed is:

1. An all solid state battery comprising an electrode stacked body including a cathode layer, an anode layer, and a solid electrolyte layer placed between the cathode layer and the anode layer; and
the electrode stacked body is confined under confining pressure of 0 MPa or more and 2 MPa or less in a thickness direction;
the anode layer includes an anode active material with a volume expansion rate due to charge of 105% or more;
the solid electrolyte layer includes a solid electrolyte and a binder; and
a ratio of the binder in the solid electrolyte layer is 4 volume % or more and 20 volume % or less.

2. The all solid state battery according to claim 1, wherein a peeling strength between the solid electrolyte layer and the anode layer is 0.20 N/cm or more.

3. An all solid state battery comprising an electrode stacked body including a cathode layer, an anode layer, and a solid electrolyte layer placed between the cathode layer and the anode layer; and
the electrode stacked body is confined under confining pressure of 0 MPa or more and 2 MPa or less in a thickness direction;
the anode layer includes an anode active material with a volume expansion rate due to charge of 105% or more;
the solid electrolyte layer includes a solid electrolyte and a binder; and
a peeling strength between the solid electrolyte layer and the anode layer is 0.20 N/cm or more and 1.04 N/cm or less.

4. The all solid state battery according to claim 1, wherein the anode active material is a Si based active material.

5. The all solid state battery according to claim 1, wherein the solid electrolyte is a sulfide solid electrolyte.

6. The all solid state battery according to claim 1, wherein the electrode stacked body includes an anode current collector at a location on opposite side to the solid electrolyte layer, with respect to the anode layer, and
a rough surface is formed on an anode layer side surface of the anode current collector.
